(19) United States
(12) Patent Application Publication
(10) Pub. No.: US 2015/0371291 A1
(43) Pub. Date: Dec. 24, 2015

(54) Apparatus and methods for embedding, retrieving, modifying, and using topic-suggested media in a review request

(71) Applicant: Hermann P. Calabria, Seattle, WA (US)

(72) Inventor: Hermann P. Calabria, Seattle, WA (US)

(73) Assignee: DIAMOND REVIEW, INC., Seattle, WA (US)

(21) Appl. No.: 14/311,612

(22) Filed: Jun. 23, 2014

(51) Int. Cl. G06Q 30/02; H04L 29/08; H04L 29/06

(52) U.S. Cl. CPC G06Q 30/0282; H04L 63/08; H04L 67/10

(57) ABSTRACT

A system including a review server connected to a global computer network that enables a user related to a topic to create a review request related to said topic, and to include suggested media in said review request. The system further enables a reviewing user to retrieve said review request, and create a review using all, some, or none of the suggested media. The system further enables said reviewing user to upload additional media, and to publish the review, including the media, for viewing by other users.

### FEDERALLY SPONSORED RESEARCH

None

### SEQUENCE LISTING

None

### FIELD OF THE INVENTION

The present invention is related to enabling owners or administrators of a topic such as a business to suggest media such as topic-related images to a potential reviewer, to include in a review to be written about said topic.

### SUMMARY OF THE INVENTION

Apparatus and methods enable owners or administrators of a topic, a topic typically being a business, to suggest media such as images and videos to a potential reviewer, for possible inclusion in a review to be written about said topic. The images and videos suggested to a potential reviewer typically comprise of the product or service the reviewer has purchased from the business.

The present invention also includes methods and apparatus for presenting the suggested media to a potential reviewer, and to enable the easy creation of a review with all, some, or none of the suggested media, and for the potential reviewer to upload additional media if wanted.

The finished review may be displayed on a website, mobile device, and more. Likewise, reviews and review requests may be authored on a desktop computer, a mobile device, or any other convenient computing device.

### BRIEF DESCRIPTION OF THE DRAWINGS

FIG. 1. is a diagram of the overall system in context of a global computer network

FIG. 2. is a flowchart of the steps utilized by the system to process a review request received from a computing device and including suggested media.

FIG. 3a. is a screen shot of an exemplary review request creation form that can be utilized by a user to transmit a review request to the review server.

FIG. 3b. is a screen shot of the exemplary form disclosed in FIG. 3a, after an exemplary user has pushed the “Add Photos . . . ” button and uploaded three exemplary photos of a diamond ring. The exemplary user has also submitted exemplary captions under each of the three photos.

FIG. 3c. is a screen shot of the exemplary form disclosed in FIG. 3b, illustrating a “drag and drop” operation performed by an exemplary user, wherein by doing so a suggested order of the suggested media is changed.

FIG. 4. is a table of an exemplary database table of topics. Each row in the table includes an exemplary topic id, name, and an unordered collection of users with valid credentials, as represented by the curly-bracket notation ({ }).

FIG. 5. is a table of an exemplary database table of review requests. Each row in the table includes an exemplary request id, and exemplary topic id, and an exemplary collection of one more suggested media. The square-bracket notation ([ ]) represents an ordered list of suggested media ids, which is the preferred embodiment. An unordered list would also serve the purpose of suggesting media, but would not contain information about any suggested ordering of the media, unless such ordering information is stored in some other manner. For illustrative purposes, the exemplary topic ids used in FIG. 4 correspond to the topic ids used in FIG. 5, and the media ids correspond to those used in FIG. 6.

FIG. 6. is a table of an exemplary database table of media. Each row in the table includes an exemplary media id, an exemplary media type, an exemplary media rotation, and an exemplary media caption.

FIG. 7. is a flowchart of the steps utilized by the system to transmit, receive, and process a review request creation form to a user, said form including suggested media diagram for consideration and amendment by the user.

FIG. 8. is a screen shot of an exemplary review input form that would be presented to an exemplary review author, as a result of successful processing of the exemplary form disclosed in FIG. 8. In addition to fields for entering the review, the exemplary form contains the three exemplary photos of a diamond ring uploaded and ordered by the exemplary user in FIG. 3b and FIG. 3c.

FIG. 9. is a table of an exemplary database table of reviews. Each row in the table includes an exemplary review id, topic id, user id, review content, and an ordered list of media ids.

FIG. 10. is a screen shot of an exemplary review, after being submitted by a user.

FIG. 11. is a diagram of an exemplary global computer network and related components that employs embodiments of the present invention.

FIG. 12. is a diagram of an exemplary computing device that enacts and enables the embodiments of the present invention.

### DETAILED DESCRIPTION OF THE INVENTION

A number of embodiments exist for the present invention. They are described below.

The following terminology is used in the context of the subject matter described herein.

A “review” is an evaluation by a person such as a consumer or expert, of a business, a product, a service, a creative work, a performance, a place, an event, or a person. A review consists of any one or more of: detailed text, summary text, rating (including multiple ratings by different relevant criteria), media (as defined below), or binary yes/no ratings (such as a “like”).

A “topic” is anything that can be made the subject of a review. For example, in the figures disclosed in the present patent application, the exemplary and fictitious business “ABC diamonds” is a topic. People, usually customers of a topic, may create and submit reviews about their experience with the topic. Reviews may also be written about a specific type of diamond ring, and in that case, said type of diamond ring is a second topic. Reviews may also be written about the salesperson that assisted in the sale of the diamond ring; in that case, the salesperson is a third topic.

A “review request” is an invitation made by an agent of a topic, to a recipient user, to create a review about said topic. At minimum, a review request includes a reference to the topic to be written about, such reference usually being a topic id. A review request may also include: Information about the recipient user, information about a purchase or other interaction by recipient user with topic, and suggested media.

A “user” is a natural person connecting to a review server through a user client. A user may be a person writing a review, a person reading a review, a person acting on behalf of a topic and creating a review request to send to another person, and a person receiving a review request. Alternatively, a user may be a software agent of a natural person or a topic, such as an automated software script that performs actions on behalf of said natural person, or is creating review requests on behalf of a topic, perhaps responsive to purchase transactions as they are being made or entered.

A “user client” is a computing device connected to a global computer network running a software program that allows a user to interact with a review server that is also connected to the global computer network. Examples of user clients include: A laptop computer equipped with the Microsoft Windows operating system and running the Internet Explorer web browser, a touchscreen device such as the Apple iPhone or iPad running the Safari web browser or a native software program commonly known as an “app”, such as the Pandora radio “app” or the Facebook social network “app”.

A “review server” is a computing device connected to a global computer network running software that configures it to become a review server by performing the methods or having the distinctive features disclosed herein. An example of a computing device that can be configured to become a review server includes a server computer equipped with the Linux operating system, the Apache web server, the MySQL relational database, the Perl programming language, and software that performs the methods or instills the distinctive features disclosed herein. It will be understood that there are many ways to configure a review server, and in some cases the whole of the review server is actually instantiated by a plurality of computing devices, such as might be the case for example if the relational database is instantiated in a separate machine from other components.

A “global computer network” is a worldwide system of computers, interconnected by globally-sited fiberoptic cables, microwave links, copper cables, and facilitating hardware such as routers, gateways, switches, multiplexers, transceivers, and the like. The Internet is a global computer network.

A “media”, as used in this disclosure and in the spirit of a patentee acting as his/her own lexicographer for the sake of brevity, refers to both the singular and plural form of the word “medium”, and means any kind of file or stream of data representing a digital recording of information that is palpable by any of the five human senses, such as viewable or audible information. Examples of media include: An image, a photograph, a video, an audio recording, and a file that can be used with a 3-D printer to make a palpable object.

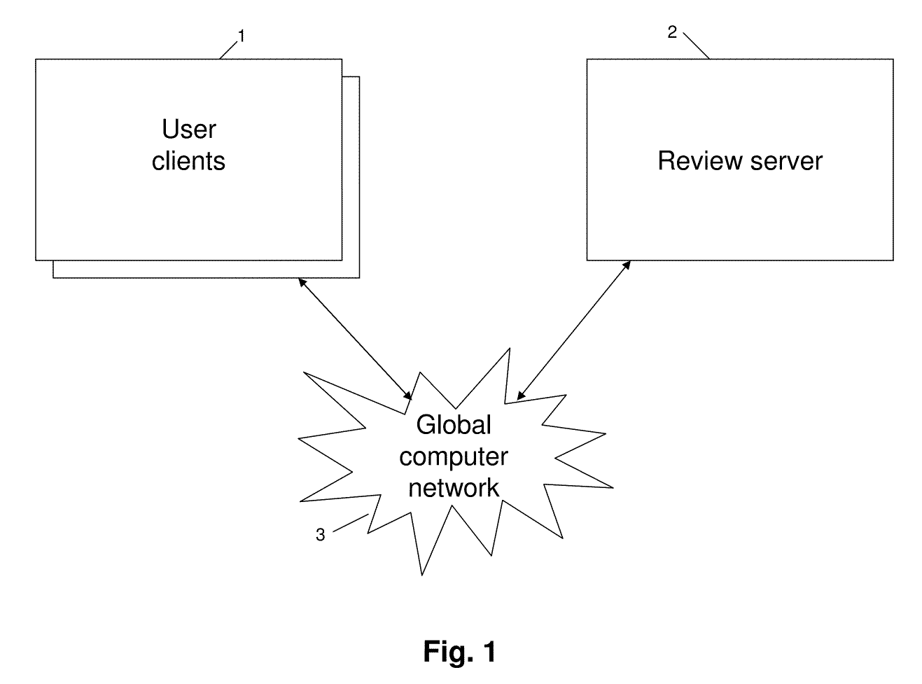

FIG. 1 discloses a review server 2 and a plurality of user clients 1, all interconnected through a global computer network 3. The preferred embodiment for the global computer network 3 is the Internet. User clients 1 may be laptop computers equipped with the Microsoft Windows operating system and running internet web browser software, a touchscreen device such as the Apple iPhone or iPad running the Safari web browser or a native software program commonly known an as an “app”. A user client 1 may also be a computer normally configured to act as a server connected to the global computer network 3, but may act as a user client on behalf of a topic to automatically create a review request.

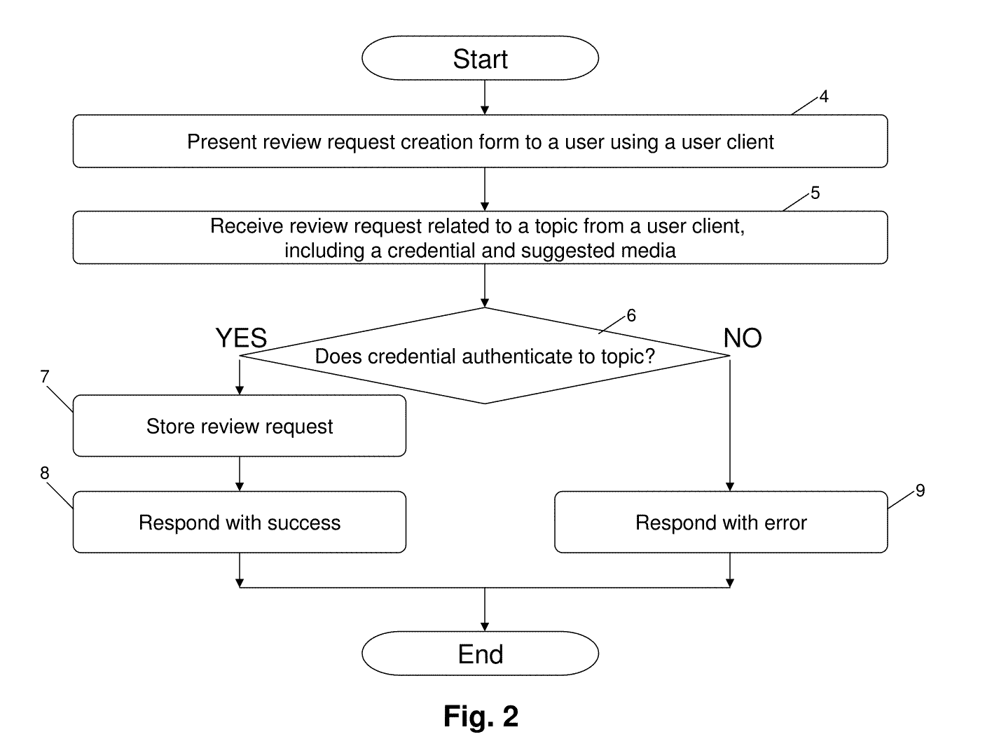

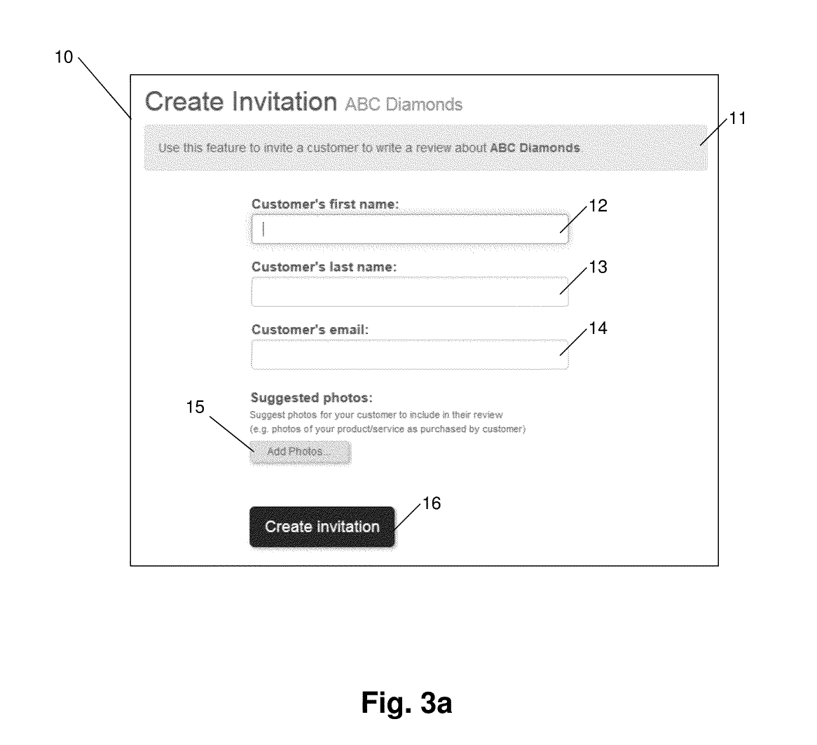

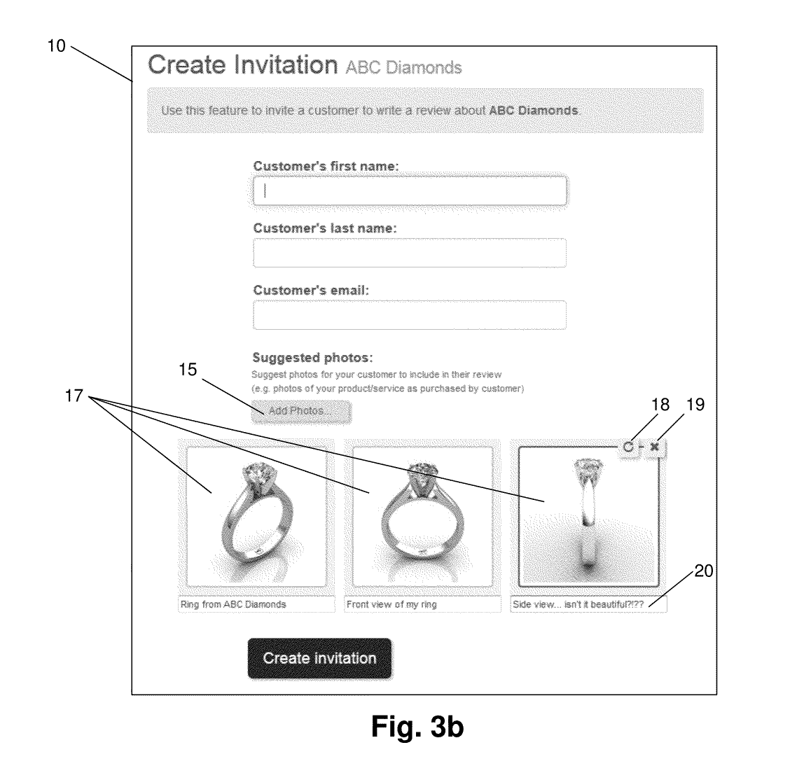

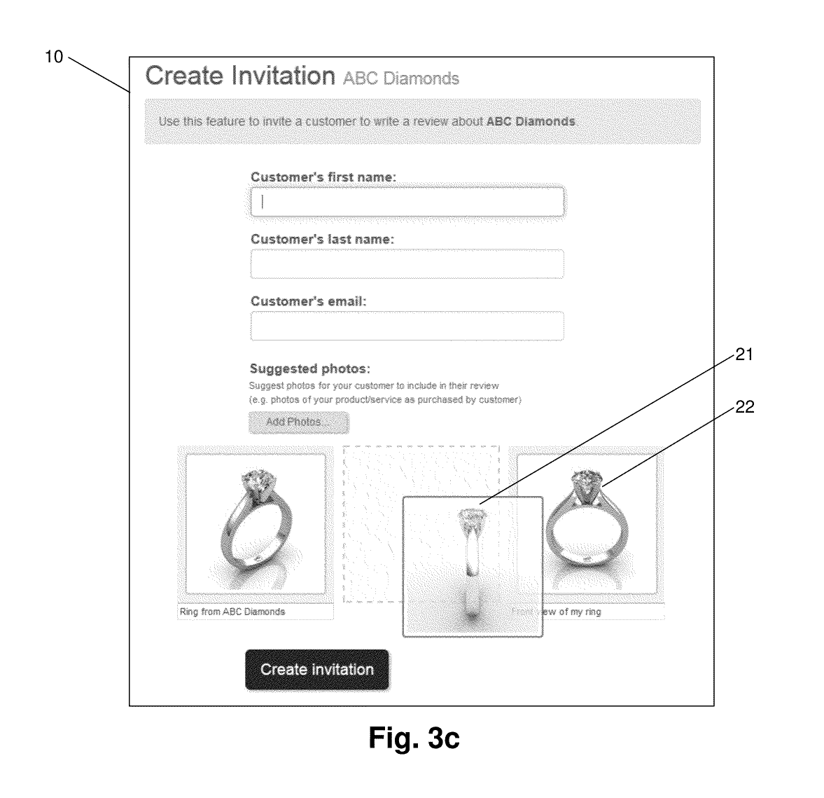

FIG. 2 is a flowchart of a sequence of steps that occurs within the review server 2 to present, receive, and process a review request about a topic. The sequence begins with an optional step 4, where the review server presents a review request creation form to a user using a user client. Step 4 is optional because, in some cases such as when the user client is a server acting automatically on behalf of the topic, the user client has been previously configured to send specified review request information (which the review server receives in step 5), and therefore does not require the guidance of an input form. If step 4 is performed, one convenient method of presenting the form is to transmit HTML for processing and presentation by a web browser software running within the user client. 10 is one such exemplary form, as disclosed in FIG. 3a (and related FIG. 3b and FIG. 3c), and includes an alert 11 to provide guidance to the user utilizing the user client, a customer's first name field 12, a customer's last name field 13, a customer's email field 14, an “Add Photos . . . ” button 15 that when pressed can be used to add suggested media to the review request, and a “Create Invitation” button 16 that can be used to submit the completed review request to the review server for processing.

Step 5 in the sequence of steps comprises of receiving the review request. The review request contains, at minimum, a reference to the topic intended to be reviewed by an intended recipient of the review request. In addition, the review request may contain information related to the intended recipient, such as the recipient's first name, last name, email address, and other personally-identifying information, some of which may be later used as registration information. If using a form, this information may be entered into text fields 12, 13, and 14, as previously described. In addition, the review request may contain information related to a purchase made by the intended recipient, such as an invoice number of the topic, unique to the purchase.

In addition, the review request may contain suggested media. Suggested media are provided by the topic (or topic's agent) and may be images, photographs, videos, or any other media suggestive of the purchase made by the intended recipient. If using a form, such as exemplary form 10, the “Add Photos . . . ” button 15 may be used within the form to add suggested media. FIG. 3b illustrates the form after adding three exemplary suggested media 17, depicting a diamond ring. In the exemplary form, it is possible for a user to add additional suggested media by pressing the “Add Photos . . . ” button 15. It is also possible for a user to delete any one or more of the suggested media already added, by pressing the delete button 19 on the media to delete, which appears momentarily when a user utilizing a mouse hovers over a given media. The present invention also enables a user to associate a rotation information with any media. If using a form, the user may press the rotate button 18 repeatedly until the media is displayed with the desired rotation. When a user specifies a rotation information for a given media, said rotation information is associated with the given media when received by the review server from the user client. The present invention also enables a user to associate a caption with any media. If using a form, the user may enter the caption into text field 20. When a user specifies a caption for a given media, said caption is associated with the given media when received by the review server from the user client. The present invention also enables a user to associate a suggested ordering of two or more of the suggested media. If using a form, the user may set the suggested ordering by “dragging & dropping” any one or more suggested media into a new location relative to other suggested media, as illustrated in FIG. 3c, wherein the suggested media 21 which was previously in the third position, is being moved by the user to the second position, which in turn moves the suggested media 22, previously in the second position, into the third position, thereby setting a suggested ordering, and said suggested ordering received by the review server when step 5 is executed.

If the user is using a form to create the review request, pushing the “create invitation” button 16 will cause the user client to transmit the review request to the review server, and therefore initiate step 5.

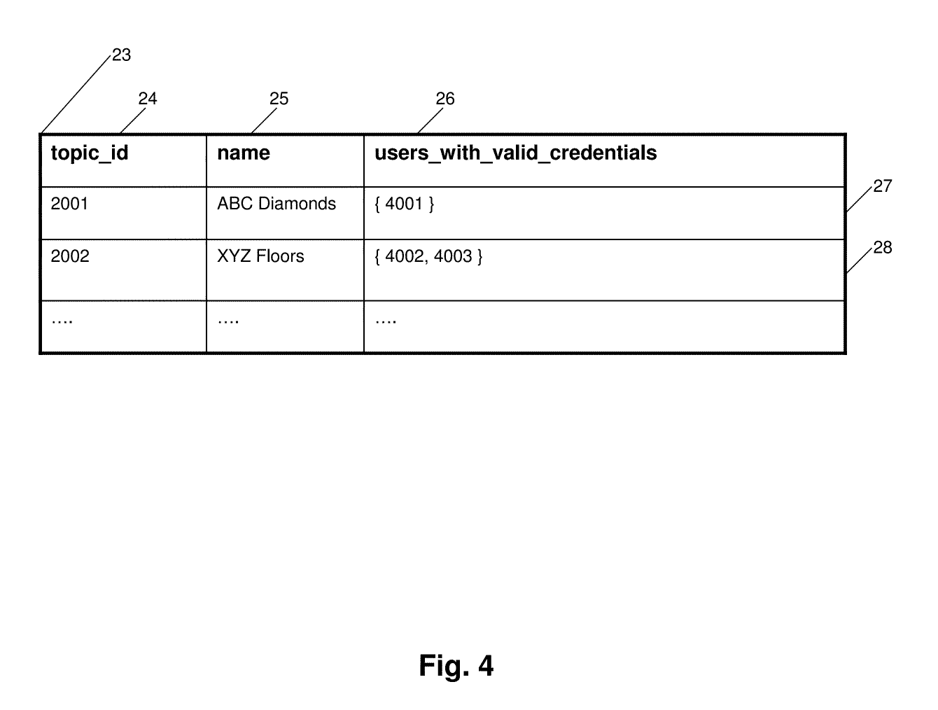

To prevent unauthorized review requests on behalf of a topic, it is highly desirable to require a credential, and include it in the review request. One simple example of a credential is a username and password that matches to the topic for which a review request is being made. In the preferred embodiment, a group of one or more known users are granted credentials associated with one more topics, and said credentials authorize said users to create review requests on behalf of said topic. FIG. 4 illustrates an exemplary topic table 23, and contains a topic id column 24, a name column 25, and a users-with-valid-credentials column 26. When the review server receives a review request about a topic from a user, the review server checks the topic table to make sure the user has valid credentials for the given topic. For example, if exemplary user id 4001 attempts to create a review request for topic id 2001, the request will match row 27, and will be granted. If user id 4001 attempts to create a review request for topic id 2002, the request will be denied because only users 4002 and 4003 have valid credentials for topic id 2002, as illustrated in row 28. In the preferred embodiment, a unique session token identifying a known user is the credential. In step 6, the review server checks the credential, as previously described, to make sure it authenticates to the topic for which the review request is being made. If the credential does not authenticates to the topic, the review server responds with an error in step 9. If the credential does authenticate to the topic, the review server stores the review request (step 7) and responds with a success message (step 8).

The present invention also makes it possible to authorize the ability to add suggested media on a topic by topic basis, perhaps as a premium service. For example, it is possible to configure the system to include an additional column in the topic table that indicates whether the given topic is able to add suggested media to review requests related to the topic. In this way, it is possible to grant certain topics the ability to add suggested media, but not grant certain other topics the same right. The system can check the review request to see if it contains suggested media, and if it does, check the additional column in the topic table to confirm the topic has the authority to add suggested media. This step can be performed at various times, but the preferred embodiment performs said check during step 6, as part of performing the other authorization checks. It will be understood there are other ways to implement this check, for example, the check could be performed on a user level, so that certain users (representing certain topics) have the right to add suggested media, whereas others do not.

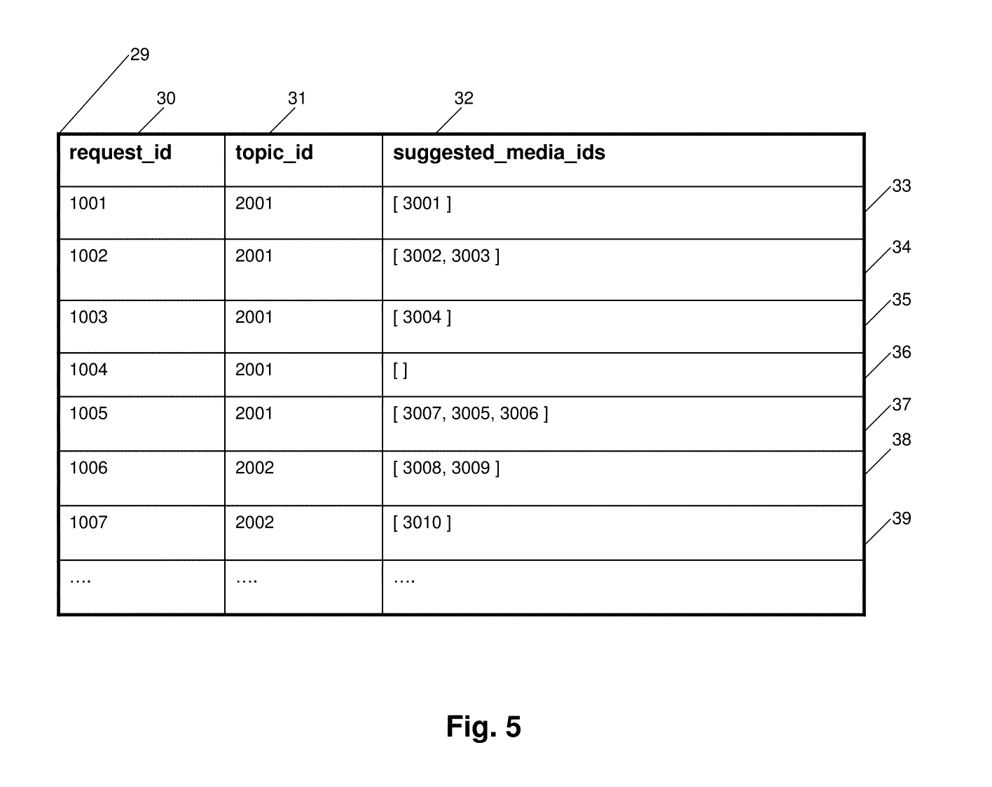

The storing step 7 is performed by the review server by adding a new row to a review request table. An exemplary review request table 29 is illustrated in FIG. 5, containing a request id column 30, a topic id column 31, and a suggested media ids column 32. A review request table may contain additional columns for storing the additional information disclosed herein, including: Information related to the intended recipient, information related to a purchase made by the intended recipient. The exemplary review request table 29 contains seven exemplary rows 33-39. Rows 33-37 contain five unique review requests, presumably to five different intended recipients, pertaining to exemplary topic id 2001. The review request in row 33 contains a single suggested media bearing an id of 3001. The review request in row 34 contains two suggested media bearing ids 3002 and 3003, and to be presented to the intended recipient in the order listed. The review request in row 36 contains no suggested media. The review request in row 37 contains three suggested media bearing ids 3007, 3005, and 3006, and are to be presented to the intended recipient in the order listed. The review requests in row 38 and 39 pertain to a different exemplary topic id 2002.

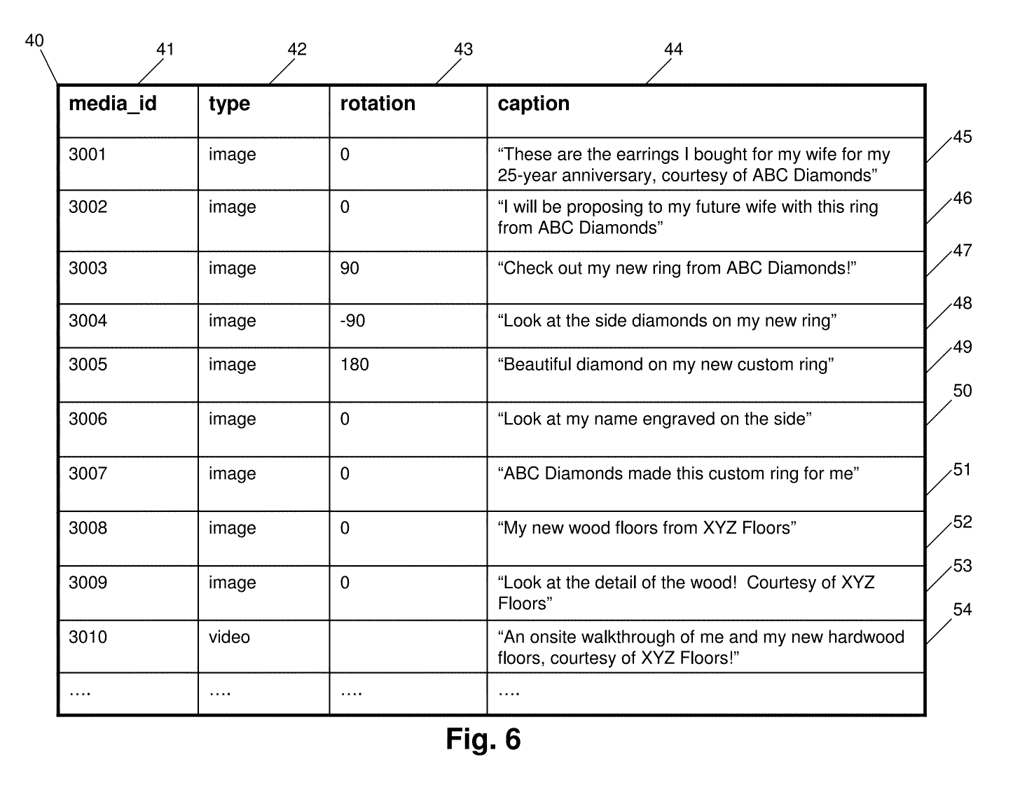

The storing step 7 also involves adding, modifying, or deleting rows to and from a media table. An exemplary media table 40 is illustrated in FIG. 6, containing a media id column 41, a type column 42, a rotation column 43, and a caption column 44. A media table may contain additional columns for storing additional information pertaining to each of the media. In addition, each of the actual media files must be stored. In the preferred embodiment, the actual media files (e.g. the image jpeg files) are stored in a Content Delivery Network (CDN), with each of the media files referenced by its media id. A person skilled in the art will readily recognize there are many other convenient ways to store the actual media files. One additional way is to create an additional column in exemplary media table 40, and store the raw media data in that column. In the MySQL relational database, such a column would be a “blob” of raw binary data.

The type column 42 refers to the type of media represented by each row. Example types are “image” as presented in rows 45-53, and “video” as presented in row 54. The rotation column 43 refers to the desired rotation (in degrees) of each media for presentation to a user. This is desirable because, often, media are incorrectly rotated relative to a viewing user. There may be cases, such as with audio-only media, where the rotation column 43 is irrelevant, and will be ignored by the review server. The caption column 44 refers to a text caption to be displayed near each media. The preferred embodiment displays the caption directly below each displayed media.

Alternatively, the adding, modifying, or deleting rows to and from a media table may partially occur prior to the storing step 7. In the preferred embodiment, using the “Add Photos . . . ” button 15 adds rows to the media table prior to the storing step 7, and modifies rows in the media table during step 7 based on any rotation, caption, or ordering information further provided by the user.

Once step 7 is completed and success is reported in step 8, the review server further provides a plurality of methods for the intended user to receive the review request. If an email is available for the intended user, the review server may automatically send an invitation to the recipient user, indicating that a review request is waiting, and including the request id or some other method of uniquely referencing the pending review request. In the preferred embodiment, the review request table 29 further includes a column with a unique alphanumeric invitation code that the recipient may use to securely access the review request. Said alphanumeric invitation code is provided to the intended recipient by email, and can also be provided to the user that creates a review request, so that said user may provide it to the intended recipient through some other means, such as through a separate email.

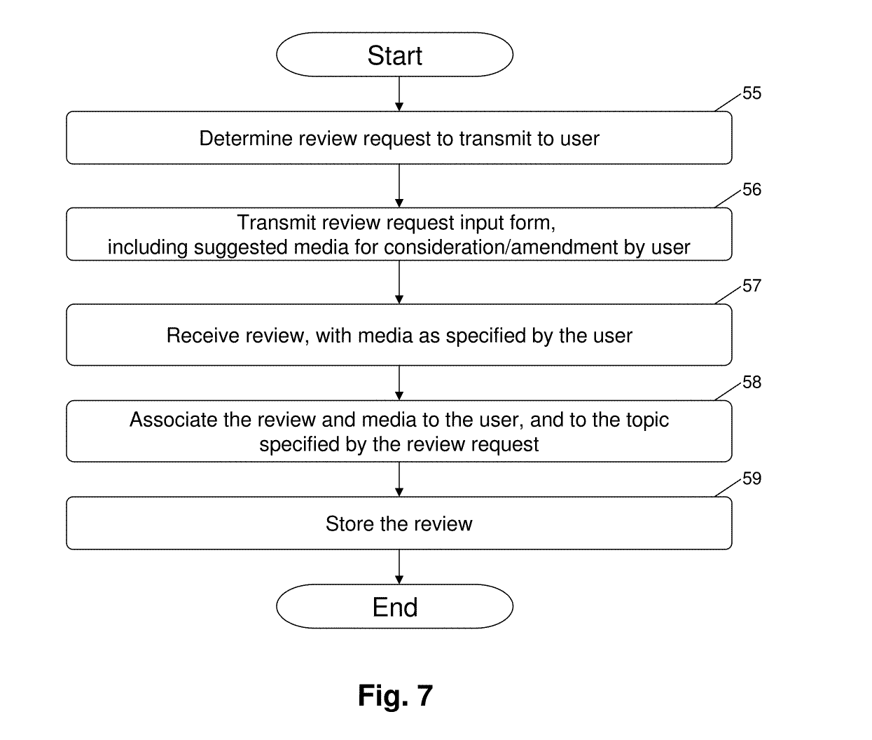

The intended recipient user retrieves a review request by any number of methods, the preferred embodiment being the alphanumeric invitation code previously discussed. Upon said user initiating the retrieval of a review request, the review server determines the review request to transmit to said user in step 55, FIG. 7, by performing a lookup against a review request table such as the exemplary review request table 29. Such a lookup can be implemented as a SQL query if the preferred embodiment using a relational database is utilized.

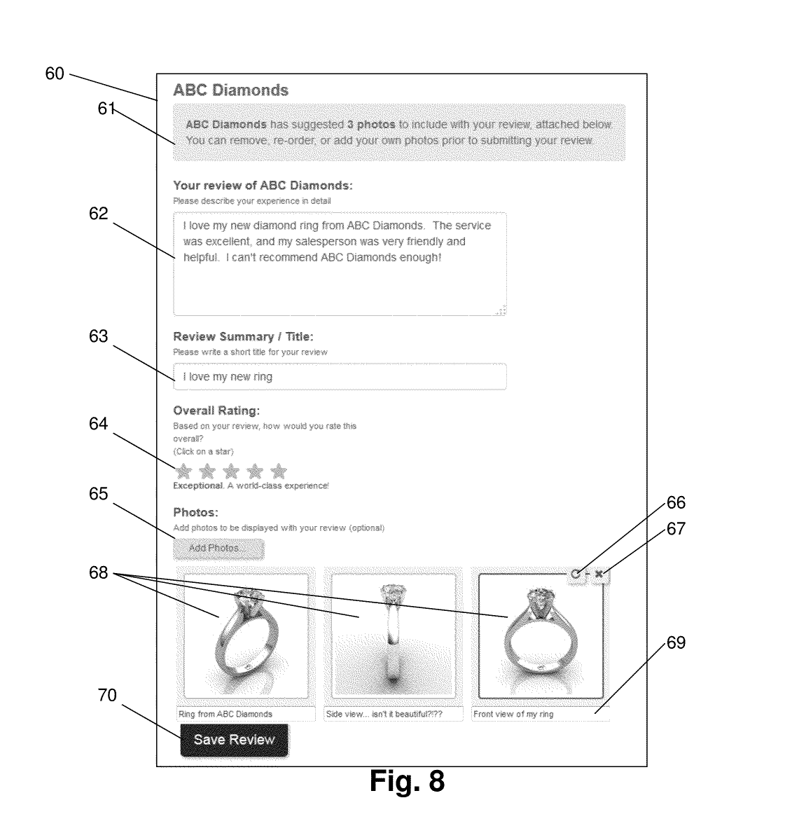

Once a review request is located, the review server performs step 56 by transmitting a review input form responsive to the lookup information provided by the user. The review input form includes suggested media for consideration/amendment by the user as previously entered by the person that created the original review request on behalf of the topic. FIG. 8 illustrates an exemplary review request input form 60. The form has an alert box 61 to inform the recipient user that suggested media 68 have been provided. The form has a detailed text input box 62 for entry of a text review, a summary text input box 63 for entry of a brief summary of the review, and a rating selector 64 for entry of a one to five star rating. Although not shown, it is possible to add a binary yes/no rating such as a “Like” or a “Vouch” to the review form 60.

The form has an “Add Photos . . . ” button 65. Its operation is similar to button 15 as previously explained; the recipient user has the option to add his/her own media by pushing button 65 and uploading the additional media. Upon doing so, his/her own media are added to the suggested media 68 by the review server. The recipient user also has the option to rotate any of the media the original suggested media or any uploaded additional media) by pushing button 66, to delete any of the media by pushing button 67, or to add/edit/remove any caption information of any media by editing the text box 69.

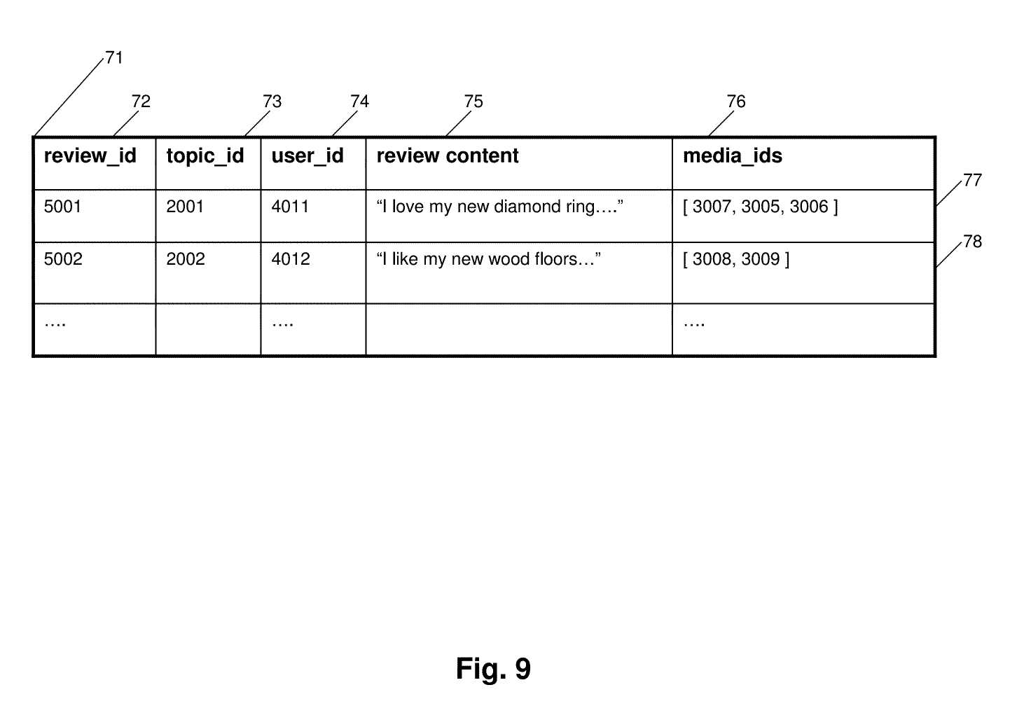

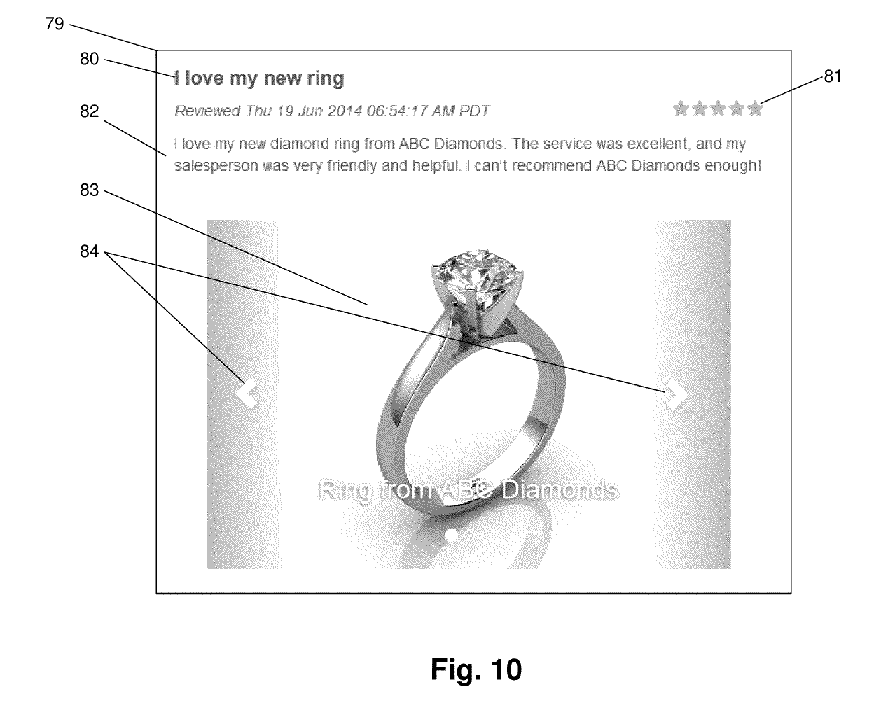

Once the recipient user is happy with the review, he/she initiates the receiving of the review by the review server by pushing “Save Review” button 70, which serves to initiate step 57, the receiving of the review by the review server, with media as specified by the recipient user. In step 58, the review and media are associated to the user and to the topic specified by the review request, and stored in a review table in step 59. An exemplary review table 71 is illustrated in FIG. 9, and contains columns review id 72, topic id 73, user id 74, review content 75, and media ids 76. The review content column 75 may contain the detailed text as illustrated, and may contain additional review information (not illustrated) such as rating, binary rating, and summary text. The media ids column 76 contains an ordered list of media to display with the review. Row 77 contains an exemplary review data that is representative of the exemplary review disclosed by FIG. 8 and FIG. 10. Row 78 contains an exemplary review data of another unrelated review.

FIG. 10 illustrates an exemplary review 79, consistent with row 77. The exemplary review contains a summary text 80, a rating 81, a detailed text 82, and a carousel-style slideshow of the media 83. The first (of three) media is displayed, along with its caption. The user may view the other two media by clicking on the forward & backward buttons 84. It is also possible to display the media in any number of other ways, such as displaying thumbnails of all media simultaneously, and allowing the user to click on a given thumbnail to enlarge it. It is also possible to display the review in any number of other ways convenient to viewing users.

The topic table 23, review request table 29, media table 40, and review table 71, can be implemented in a wide variety of ways. The preferred embodiment utilizes a relational database such as MySQL or PostgreSQL, wherein each of the three tables is instantiated within a single database, and wherein SQL queries perform some of the methods and steps described in this disclosure.

The user clients and review server are all computing devices. A global computer network is also disclosed in the present invention. Computing devices and global computer networks are described below.

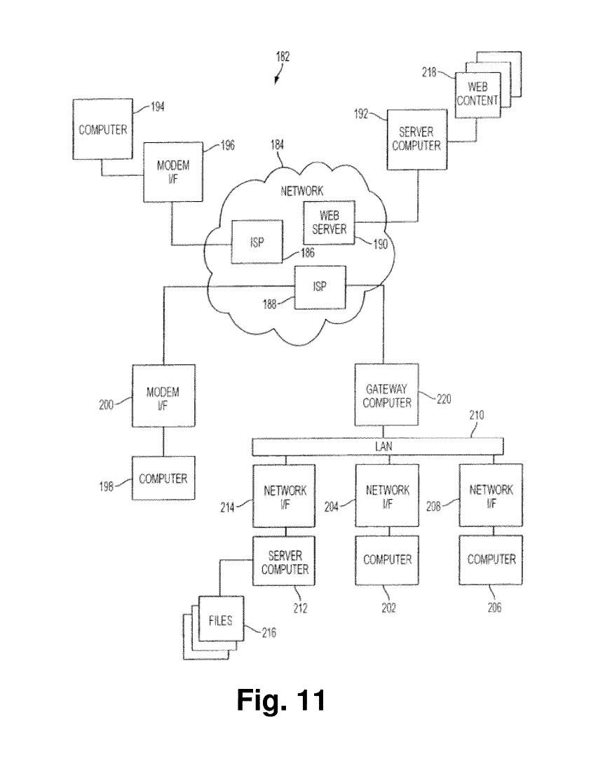

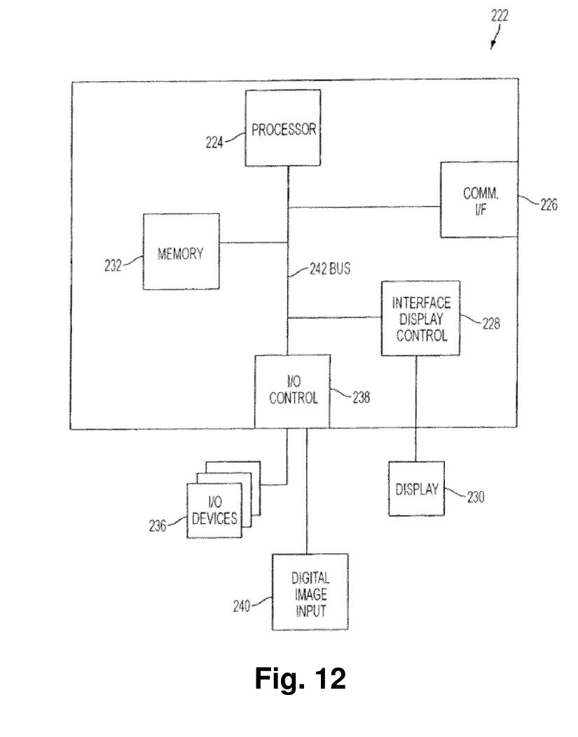

The following description of FIGS. 11 and 12 is intended to provide an overview of computer hardware and other operating components suitable for performing the methods of the invention, but is not intended to limit the many applicable environments as described above. Similarly, the computer hardware and other operating components may be suitable as part of the systems of the invention described above. The invention can be practiced with other computer system configurations, including hand-held devices, multiprocessor systems, microprocessor-based or programmable consumer electronics, network PCs, minicomputers, mainframe computers, and the like. The invention can also be practiced in distributed computing environments where tasks are performed by remote processing devices that are linked through a communications network. The invention can also be practiced within a virtual computing environment, wherein multiple computing devices are simulated by software within a single hardware computing device. Any person skilled in the art will recognize these variations in implementations of a computing device as materially equivalent for implementing the present invention.

FIG. 11 shows several computer systems 182 that are coupled together through a network 184, such as the Internet. The term “Internet” as used herein refers to a network of networks which uses certain protocols, such as the TCP/IP protocol, and possibly other protocols such as the hypertext transfer protocol (HTTP) for hypertext markup language (HTML) documents that make up the World Wide Web (web). The physical connections of the Internet and the protocols and communication procedures of the Internet are well known to those of skill in the art.

Access to the Internet 184 is typically provided by Internet service providers (ISP), such as the ISPs 186 and 188. Users on client systems, such as client computer systems 194, 198, 202, and 206 obtain access to the Internet through the Internet service providers, such as ISPs 186 and 188. Access to the Internet allows users of the client computer systems to exchange information, receive and send e-mails, and view documents, such as documents which have been prepared in the HTML format. These documents are often provided by web servers, such as web server 190 which is considered to be “on” the Internet. Often these web servers are provided by the ISPs, such as ISP 186, although a computer system can be set up and connected to the Internet without that system also being an ISP.

The web server 190 is typically at least one computer system which operates as a server computer system and is configured to operate with the protocols of the World Wide Web and is coupled to the Internet. Optionally, the web server 190 can be part of an ISP which provides access to the Internet for client systems. The web server 190 is shown coupled to the server computer system 192 which itself is coupled to web content 218, which can be considered a form of a database. While two computer systems 190 and 192 are shown in FIG. 11, the web server system 190 and the server computer system 192 can be one computer system having different software components providing the web server functionality and the server functionality provided by the server computer system 192 which will be described further below.

Client computer systems 194, 198, 202, and 206 can each, with the appropriate web browsing software, view HTML pages provided by the web server 190. The ISP 186 provides Internet connectivity to the client computer system 194 through the modem interface 196 which can be considered part of the client computer system 194. The client computer system can be a personal computer system, a network computer, a Web TV system, a wireless PDA or cellular phone or automobile navigation console, or other such computer system.

Similarly, the ISP 188 provides Internet connectivity for client systems 198, 202, and 206, although as shown in FIG. 11, the connections are not the same for these three computer systems. Client computer system 198 is coupled through a modem interface 200 while client computer systems 202 and 206 are part of a LAN. While FIG. 11 shows the interfaces 196 and 200 as generically as a “modem,” each of these interfaces can be an analog modem, ISDN modem, cable modem, satellite transmission interface (e.g. “Direct PC”), urban wireless connectivity (e.g., cellular telephony), peer-to-peer interface (e.g. 802.11 and Bluetooth), Ethernet, or other interfaces for coupling a computer system to other computer systems.

Client computer systems 202 and 206 are coupled to a LAN 210 through network interfaces 204 and 208, which can be Ethernet network or other network interfaces. The LAN 210 is also coupled to a gateway computer system 220 which can provide firewall and other Internet related services for the local area network. This gateway computer system 220 is coupled to the ISP 188 to provide Internet connectivity to the client computer systems 202 and 206. The gateway computer system 220 can be a conventional server computer system. Also, the web server system 190 can be a conventional server computer system.

Alternatively, a server computer system 212 can be directly coupled to the LAN 210 through a network interface 214 to provide files 216 and other services to the clients 202, 206, without the need to connect to the Internet through the gateway system 220.

FIG. 12 shows one example of a conventional computer system 222 that can be used as a client computer system, a server computer system, a web server system, a client portable computer system (e.g. PDA or cellular phone or automobile navigation console), a component of a smart advertising display as previously described, etc. Such a computer system 222 can be used to perform many of the functions of an Internet service provider, such as ISP 186. The computer system 222 interfaces to external systems through the modem or network interface 226. It will be appreciated that the modem or network interface 226 can be connected to the global computer network 3 (as shown in FIG. 1) and to be part of the computer system 222. This interface 226 can be an analog modem, ISDN modem, cable modem, token ring interface, satellite transmission interface (e.g. “Direct PC”), urban wireless connectivity (e.g., cellular telephony), peer-to-peer interface (e.g., 802.11 and Bluetooth), or other interfaces for coupling a computer system to other computer systems.

The computer system 222 includes a processor 224, which can be a conventional microprocessor such as an Intel® Pentium® microprocessor or Motorola® PowerPC® microprocessor. Memory 232 is coupled to the processor 224 by a bus 242. Memory 232 can be dynamic random access memory (DRAM) and can also include static RAM (SRAM). The bus 242 couples the processor 224 to the memory 232, to display controller 228, and to the input/output (I/O) controller 238.

The interface display controller 228 controls in the conventional manner a display on a display device 230 which can be a cathode ray tube (CRT) or liquid crystal display (LCD) or similar. The input/output devices 236 can include a keyboard, disk drives, printers, a scanner, and other input and output devices, including a mouse or other pointing device. The display controller 228 and the I/O controller 238 can be implemented with conventional well known technology. A digital image input device 240 can be a digital camera which is coupled to an I/O controller 238 in order to allow images from the digital camera to be input into the computer system 222.

One of skill in the art will immediately recognize that the terms “machine readable medium” or “computer-readable medium” includes any type of storage device that is accessible by the processor 224 and also encompasses a carrier wave that encodes a data signal.

The computer system 222 is one example of many possible computer systems which have different architectures. For example, personal computers based on an Intel microprocessor often have multiple buses, one of which can be an input/output (I/O) bus for the peripherals and one that directly connects the processor 224 and the memory 232 (often referred to as a memory bus). The buses are connected together through bridge components that perform any necessary translation due to differing bus protocols.

Network computers are another type of computer system that can be used with the present invention. Network computers do not usually include a hard disk or other mass storage, and the executable programs are loaded from a network connection into the memory 232 for execution by the processor 224. A Web TV system or a mobile phone, which is known in the art, is also considered to be a computer system according to the present invention, but it may lack some of the features shown in FIG. 12, such as certain input or output devices. A typical computer system will usually include at least a processor, memory, and a bus coupling the memory to the processor.

In addition, the computer system 222 is controlled by operating system software which includes a file management system, such as a disk operating system, which is part of the operating system software. One example of an operating system software with its associated file management system software is the family of operating systems known as Windows from Microsoft Corporation of Redmond, Wash., and their associated file management systems. Another example of an operating system software with its associated file management system software is the LINUX operating system and its associated file management system. Another example of an operating system software is iOS and Android. The file management system is typically stored in the memory 232 and causes the processor 224 to execute the various acts required by the operating system to input and output data and to store data in memory.

Some portions of the detailed description are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The present invention, in some embodiments, also relates to apparatus for performing the operations herein. This apparatus may be specially constructed for the required purposes, or it may comprise a general purpose computer selectively activated or reconfigured by a computer program stored in the computer. Such a computer program may be stored in a computer readable storage medium, such as, but is not limited to, any type of disk including hard disks, floppy disks, optical disks, CD-ROMs, and magnetic-optical disks, read-only memories (ROMs), random access memories (RAMs), EPROMs, EEPROMs, magnetic or optical cards, or any type of medium suitable for storing electronic instructions or data, and each coupled to a computer system bus.

The algorithms and displays presented herein are not inherently related to any particular computer or other apparatus. Various general purpose systems may be used with programs in accordance with the teachings herein, or it may prove convenient to construct more specialized apparatus to perform the required method steps. The required structure for a variety of these systems will appear from the description below. In addition, the present invention is not described with reference to any particular programming language, and various embodiments may thus be implemented using a variety of programming languages.

The systems described in FIGS. 11-12 are therefore capable of enabling the methods described herein regarding the user clients 1, the review server 2, the global computer network 3, and the features provided to allow users to interface with the system.

While the above description contains many specificities, these should not be construed as limitations on the scope of any embodiment, but as exemplifications of various embodiments thereof. One skilled in the art will appreciate that although specific embodiments of the present system and methods have been described for purposes of illustration, various modifications can be made without deviating from the scope or spirit of the present invention. Many other ramifications and variations are possible within the teachings of the various embodiments. Thus the scope should be determined by the appended claims and their legal equivalents, and not by the examples given.

1. A method of configuring a review server connected to a global computer network to process one or more suggested media related to a topic, said method comprising:
receiving a review request from a first user client, said review request including a credential and the suggested media;
determining whether said credential authenticates said first user client to said topic; and
storing said review request.

2. The method of claim 1, further comprising transmitting a review request input form to the first user client, said review request input form enabling a first user to create the review request, said review request including the suggested media.

3. The method of claim 1, wherein the review request further includes a suggested ordering of two or more of the suggested media.

4. The method of claim 1, wherein at least one of the suggested media is associated with a caption, said caption received from said first user client.

5. The method of claim 1, wherein at least one of the suggested media is an image.

6. The method of claim 1, further comprising the steps:
transmitting a review input form to a second user client, said review input form including the one or more suggested media, and said review input form enabling a second user to create a review related to the topic and include at least one of the suggested media in said review;
receiving the review from the second user client, said review including at least one of the suggested media;
associating the review with the topic; and
storing said review.

7. The method of claim 6, wherein the transmitting is responsive to providing by the second user client of a unique reference to the review request.

8. The method of claim 6, wherein the review input form is configured to enable said second user to exclude at least one of the suggested media from said review.

9. The method of claim 6, wherein the review input form is configured to enable said second user to include one or more additional media in said review, said additional media not included in the review request.

10. The method of claim 6, wherein at least one of the suggested media is related to a purchase made by said second user, and said purchase is related to said topic.

11. A review server for processing one or more suggested media related to a topic, said review server comprising:
an interface for receiving a review request from a first user client, said review request including a credential and the suggested media;
a processor for determining whether said credential authenticates said first user client to said topic; and
a storage device for storing said review request.

12. The review server recited in claim 11, wherein the interface is further configured for transmitting a review request input form to the first user client, said review request input form enabling a first user to create the review request, said review request including the suggested media.

13. The review server recited in claim 11, wherein the review request further includes a suggested ordering of two or more of the suggested media

14. The review server recited in claim 11, wherein at least one of the suggested media is associated with a caption, said caption received from said first user client.

15. The review server recited in claim 11, wherein at least one of the suggested media is an image.

16. The review server recited in claim 11, wherein
the interface is further configured for transmitting a review input form to a second user client, said review input form including the one or more suggested media, and said review input form enabling a second user to create a review related to the topic and include at least one of the suggested media in said review;
the interface is further configured for receiving the review from the second user client, said review including at least one of the suggested media;
the processor is further configured for associating the review with the topic; and
the storage device is further configured for storing said review.

17. The review server recited in claim 16, wherein the interface is further configured for transmitting responsive to receiving from the second user client a unique reference to the review request.

18. The review server recited in claim 16, wherein the review input form is configured to enable said second user to exclude at least one of the suggested media from said review.

19. The review server recited in claim 16, wherein the review input form is configured to enable said second user to include one or more additional media in said review, said additional media not included in the review request.

20. The review server recited in claim 16, wherein at least one of the suggested media is related to a purchase made by said second user, and said purchase is related to said topic.
